(19) United States
(12) Patent Application Publication
(10) Pub. No.: US 2006/0141356 A1
(43) Pub. Date: Jun. 29, 2006

(54) Electrochemical device

(76) Inventors: Tetsuya Takahashi, Tokyo (JP); Yousuke Miyaki, Tokyo (JP); Atsuko Kosuda, Tokyo (JP); Masayuki Ohtsuka, Tokyo (JP); Kunio Miyabara, Tokyo (JP)

Correspondence Address: OLIFF & BERRIDGE, PLC, P.O. BOX 19928, ALEXANDRIA, VA, 22320, US

(21) Appl. No.: 10/560,366

(22) PCT Filed: Jun. 11, 2004
(86) PCT No.: PCT/JP04/08573

§ 371 Date: Feb. 15, 2006

(30) Foreign Application Priority Data
Jun. 13, 2003 (JP) 2003-169974

(51) Int. Cl. H01M 2/08; H01M 2/02

(52) U.S. Cl. 429/185; 429/176

(57) ABSTRACT

In an electric double layer capacitor 100 comprising an electrochemical element 30 including a pair of electrode layers 32, 36; a pair of container members 10, 20 made of a metal surrounding the electrochemical element 30; and an electrically insulative gasket 40, interposed between the pair of container members 10, 20, for electrically insulating the container members 10, 20 from each other; the electrochemical element 30 is sealed by causing a crimping part 10bof one container member 10 to crimp a brim 20b of the other container member 20 while interposing the gasket 40 between the crimping part 10b of one container member 10 and the brim 20b of the other container member 20, whereas the crimping part 10b of one container member 10 and the brim 20b of the other container member 20 are bonded to each other by the gasket 40.

### TECHNICAL FIELD

The present invention relates to an electrochemical device in which an electrochemical element having a pair of electrode layers is sealed within a container.

### BACKGROUND ART

Electrochemical devices of so-called coin type or button type, in which an electrochemical element having a pair of electrode layers is sealed within a thin cylindrical container, such as coin batteries, have been known. The container in such a coin-type electrochemical device includes a lower lid for accommodating an electrochemical element and an upper lid for sealing the lower lid, for example. With a gasket interposed between the lower and upper lids, an end part of the upper lid is bent, so as to crimp an end part of the lower lid by holding it from the outside, thus sealing the electrochemical element.

In the coin-type electrochemical devices currently used in general, each of the upper and lower lid materials has a thickness of 200 to 300 μm.

### DISCLOSURE OF THE INVENTION

Along with a trend in recent years to reduce the size and weight of electrochemical devices, there has been a demand for thinning such a coin-type electrochemical device as a whole so as to achieve a thickness of 1 mm or less, for example. To this aim, it is necessary for the upper and lower lid materials of the container to reduce their thickness sufficiently. When the upper and lower lid materials are made thinner, however, the upper and lower lids decrease their strength, whereby their crimped parts are more likely to peel off.

In view of the problem mentioned above, it is an object of the present invention to provide an electrochemical device in which crimped parts are harder to peel off even when container materials are made thinner.

In one aspect, the present invention provides an electrochemical device comprising an electrochemical element including a pair of electrode layers; a pair of container members made of a metal surrounding the electrochemical element; and an electrically insulative gasket, interposed between the pair of container members, for electrically insulating the container members from each other; wherein the electrochemical element is sealed by causing an end part of one container member to crimp an end part of the other container member while interposing the gasket between the end part of one container member and the end part of the other container member, one of the pair of electrode layers being electrically connected to one container member, the other of the pair of electrode layers being electrically connected to the other container member; and wherein the end part of one container member and the end part of the other container member are bonded to each other by the gasket.

Since the gasket bonds the end part of one container member to the end part of the other container member in the electrochemical device in accordance with this aspect of the present invention, the end part of one container member, which is a crimped part, is harder to peel off. This makes it easier to keep the sealing performance in the electrochemical device even when the container members are made thinner.

Here, it will be preferred if the gasket contains at least one of acid-denatured polypropylene and acid-denatured polyethylene.

This can easily bond the end part of one container member and the end part of the other container member to each other by heating the gasket after crimping.

Preferably, one container member and the other container member are bonded to each other by heating the gasket after causing the end part of one container member to crimp the end part of the other container member. This facilitates the bonding operation.

In another aspect, the present invention provides an electrochemical device comprising an electrochemical element including a pair of electrode layers; a pair of container members made of a metal surrounding the electrochemical element; and an electrically insulative gasket, interposed between the pair of container members, for electrically insulating the container members from each other; wherein the electrochemical element is sealed by causing an end part of one container member to crimp an end part of the other container member while interposing the gasket between the end part of one container member and the end part of the other container member, one of the pair of electrode layers being electrically connected to one container member, the other of the pair of electrode layers being electrically connected to the other container member; the electrochemical device further comprising an electrically insulative resin part bonded from one container member to the other container member so as to cover a joint between one container member and the other container member.

In the electrochemical device in accordance with this aspect of the present invention, the end part of one container member, which is a crimped part, is protected by the resin part, so as to become harder to peel off. This makes it easier to keep the sealing performance in the electrochemical device even when the container members and lid members are made thinner.

Here, it will be preferred if the end part of one container member and the end part of the other container member are bonded to each other by the gasket.

This makes the end part of one container member harder to peel off, since the end parts of the container members are bonded to each other by the gasket as well.

### BRIEF DESCRIPTION OF THE DRAWINGS

FIG. 1 is a sectional view showing the electric double layer capacitor in accordance with a first embodiment;

FIG. 2A is an explanatory view showing a method of manufacturing the electric double layer capacitor of FIG. 1;

FIG. 2B is an explanatory view, subsequent to FIG. 2A, showing the manufacturing method for FIG. 1;

FIG. 3 is a sectional view showing the electric double layer capacitor in accordance with a second embodiment;

FIG. 4 is a sectional view showing an example of mounting the electric double layer capacitor of FIG. 3; and

FIG. 5 is a table listing internal resistances, discharging capacities, load test results, etc. of electric double layer capacitors in accordance with examples and comparative examples.

### BEST MODES FOR CARRYING OUT THE INVENTION

In the following, preferred embodiments of the electrochemical device in accordance with the present invention will be explained in detail with reference to the accompanying drawings. In the explanation of the drawings, constituents identical or equivalent to each other will be referred to with numerals identical to each other without repeating their overlapping descriptions.

### FIRST EMBODIMENT

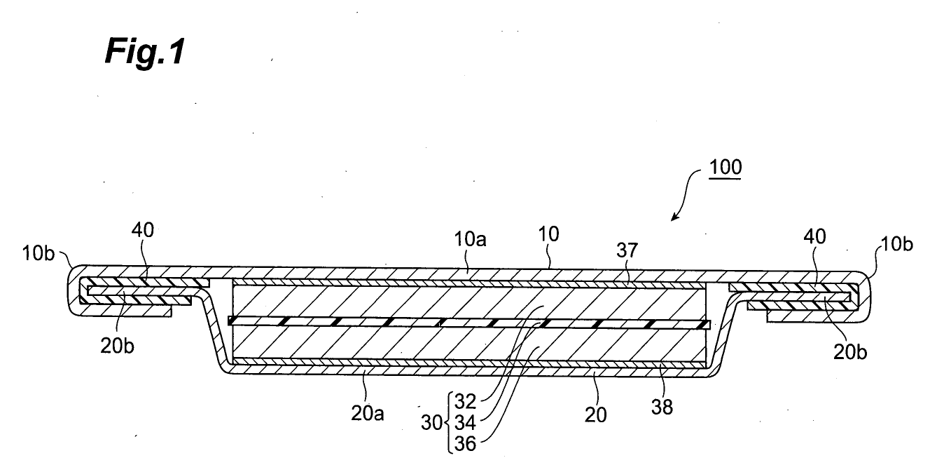

FIG. 1 shows a coin-type electric double layer capacitor 100 as the electrochemical device in accordance with an embodiment of the present invention.

This electric double layer capacitor 100 mainly comprises an electric double layer capacitor element (electrochemical element) 30, an upper lid (one container member) 10 and a lower lid (the other container member) 20 which act as container members for sealing the electric double layer capacitor element 30 by holding it from the upper and lower sides, and a gasket 40 for electrically insulating the upper lid 10 and lower lid 20 from each other.

The electric double layer capacitor element 30 mainly comprises a planar separator 34, and an anode (electrode layer) 32 and a cathode (electrode layer) 36 which oppose each other by way of the separator 34 interposed therebetween.

Each of the anode 32 and cathode 36 comprises an electronically conductive porous body and an electrolytic solution contained therein. Examples of such a porous body include those whose constituent materials are mainly composed of carbon materials (e.g., activated carbon) obtained by activating coking coke (e.g., petroleum coke manufactured by a delayed coker from material oils such as bottom oils of fluidized catalytic crackers for petroleum-based heavy oils and residual oils of vacuum distillers).

The anode 32 is electrically connected to the upper lid 10 by way of a collector layer 37. The cathode 36 is electrically connected to the lower lid 20 by way of a collector layer 38. The collectors 37 and 38 are not restricted in particular as long as they are conductors which can sufficiently transfer electric charges to the anode 32 and cathode 36, respectively, whereby foils of metals such as aluminum can be utilized, for example.

The separator 34 is an ion-permeable, insulative porous body, for which electrochemical elements of films made of polyethylene, polypropylene, and polyolefin, extended films of mixtures of the resins mentioned above, fibrous nonwoven fabrics made of at least one species of constituent material selected from the group consisting of cellulose, polyester, and polypropylene, and the like can be utilized. The separator 34 contains the electrolytic solution therewithin.

The electrolytic solution contained in the anode 32, cathode 36, and separator 34 is not restricted in particular, whereby known electrolytic solutions (aqueous electrolytic solutions and electrolytic solutions using organic solvents) employed in electrochemical devices such as electric double layer capacitors can be used. Typical examples include those in which quaternary ammonium salts such as tetraethylammonium tetrafluoroborate are dissolved in organic solvents such as propylene carbonate, diethylene carbonate, and acetonitrile.

The upper lid 10 and lower lid 20 surround the electric double layer capacitor element 30 by holding it from the upper and lower sides.

The lower lid 20 is formed from a foil of a metal such as aluminum. The lower lid 20 comprises a cylindrical part 20a having a closed lower end and an open upper end, and a brim 20b (end part) formed like a ring projecting outward from the upper end part of the cylindrical part 20a. The bottom part of the cylindrical part 20a of the lower lid 20 is in contact with the collector layer 38.

The upper lid 10 is formed from a foil of a metal such as aluminum, and comprises a planar center part 10a covering the opening of the lower lid while in contact with the collector layer 37, and a crimping part (end part) 10b, disposed along the periphery of the center part 10a, for crimping the brim 20b of the lower lid by holding it from the upper and lower sides.

Specifically, while the insulative gasket 40 is interposed between the crimping part 10b of the upper lid 10 and the brim 20b of the lower lid 20, the crimping part 10b extends outward along the depicted upper face of the brim 20b of the lower lid 20, then is bent downward at the outer side edge of the brim 20b, and further extends inward along the lower face of the brim 20b. While the gasket 40 is interposed between the crimping part 10b and the brim 20b, the crimping part 10b crimps the brim 20b by holding it from the upper and lower sides. Thus, the electric double layer capacitor element 30 is sealed within a shell formed by the upper lid 10 and lower lid 20.

Since the center part 10a of the upper lid 10 is electrically connected to the anode 32 of the electric double layer capacitor element 30 by way of the collector layer 37, the upper lid 10 functions as a negative electrode of the electric double layer capacitor 100. Since the bottom part of the cylindrical part 20a of the lower lid 20 is electrically connected to the cathode 36 of the electric double layer capacitor element 30 by way of the collector layer 38, the lower lid 20 functions as a positive electrode of the electric double layer capacitor 100. The gasket 40 electrically insulates the upper lid 10 and lower lid 20 from each other.

In particular, the gasket 40 bonds the crimping part 10b of the upper lid 10 and the brim 20b of the lower lid 20 to each other in this embodiment.

A resin adapted to bond with a metal can be used as such a gasket 40. Preferred examples include resins such as acid-denatured polypropylene and acid-denatured polyethylene. When such a resin adapted to bond with a metal upon heating is used as the gasket 40, the gasket 40 can easily bond the upper lid 10 and lower lid 20 to each other upon external heating after the crimping part 10b crimps the brim 20b of the lower lid 20 by way of the gasket 40. Crimping and bonding may be performed simultaneously by using an adhesive such as epoxy resin as the gasket 40.

Since the gasket 40 bonds the crimping part 10b of the upper lid 10 and the brim 20b of the lower lid 20 to each other, the crimping part 10b of the upper lid 10 is harder to peel off in the electric double layer capacitor in accordance with this embodiment. This makes it easier to keep the sealing performance in the electric double layer capacitor even when the upper lid 10 and lower lid 20 are sufficiently thinner than conventional ones. Therefore, troubles such as leakage are reduced.

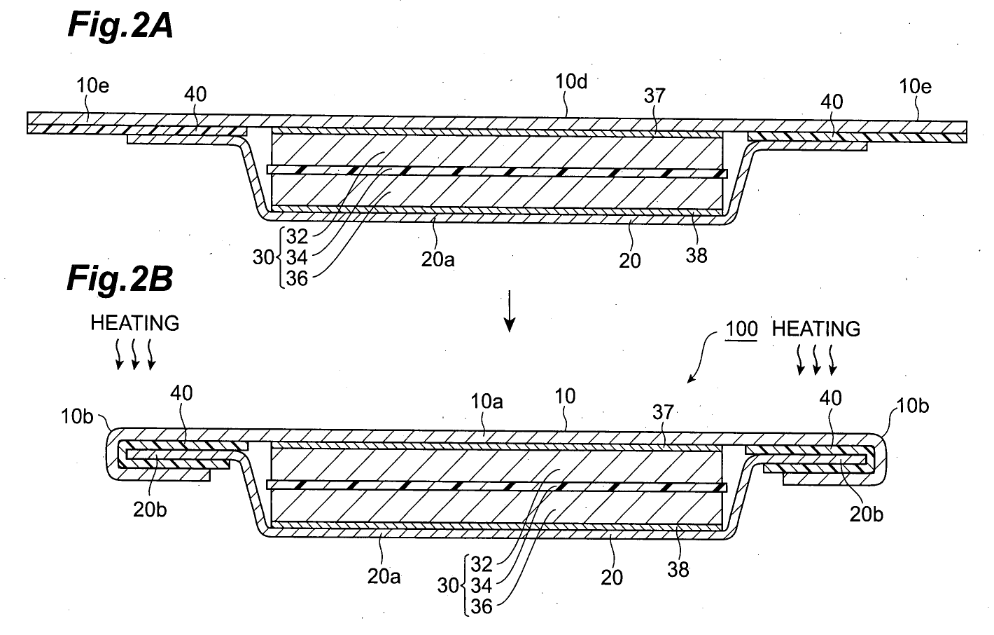

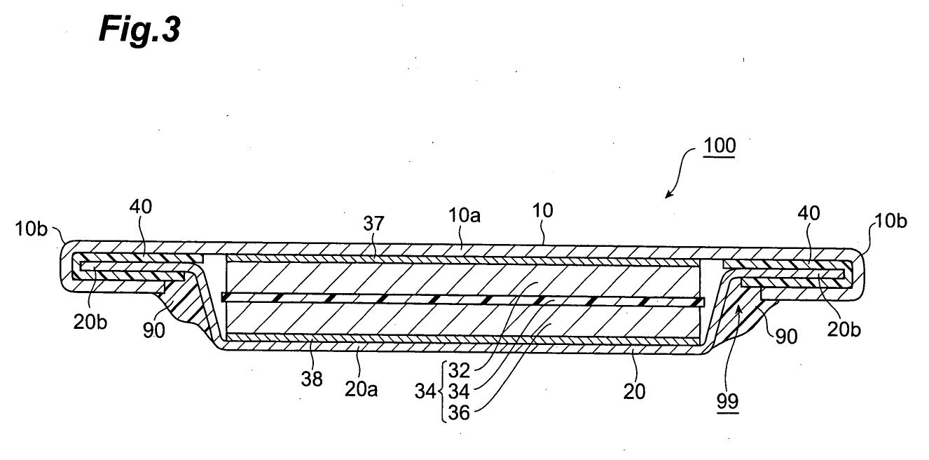

An example of method of manufacturing the electric double layer capacitor element 30 as such an electrochemical device will now be explained. First, a metal foil is shaped, so as to prepare a cylindrical lower lid 20 with a brim 20b and a flat upper lid 10d. Subsequently, an electric double layer capacitor element 30 provided with collector layers 37, 38 is accommodated in the lower lid 20, and the opening of the lower lid 20 is covered with the upper lid 10 while an electrically insulative gasket 40 containing a material adapted to exhibit adhesiveness to the metal upon heating is disposed on the brim 20b of the lower lid 20 (see FIG. 2a).

Next, an end part 10e of the upper lid 10d is bent downward, so as to hold the brim 20b from the upper and lower sides, and the end part 10e is caused to crimp the brim 20b, so as to form a crimping part 10b, thereby sealing the electric double layer capacitor element 30 (see FIG. 2b).

Subsequently, the crimping part 10b is heated from the outside, so as to melt the gasket 40, thereby bonding the upper lid 10 and lower lid 20 to each other with the gasket 40. This completes the electric double layer capacitor 100 as shown in FIG. 1.

Though the above-mentioned embodiment uses the gasket 40 adapted to exhibit adhesiveness to the metal upon heating and carries out heat treatment after crimping, so as to effect bonding, an electrically insulative resin having adhesiveness may be applied as a gasket to the upper and lower faces of the brim 20b, and then the upper lid may be mounted thereon and crimped, for example.

### SECOND EMBODIMENT

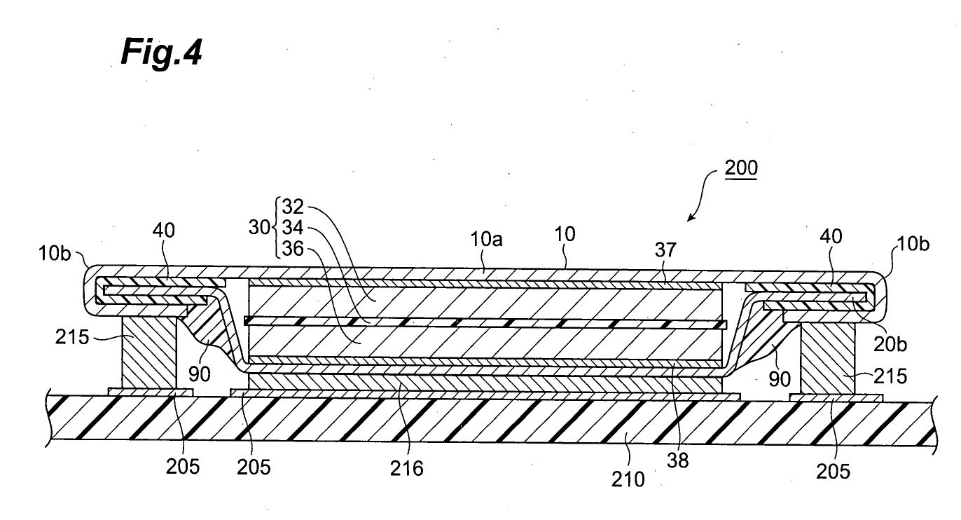

A coin-type electric double layer capacitor 200 as the electrochemical device in accordance with a second embodiment will now be explained with reference to FIG. 3. The electric double layer capacitor 200 in accordance with this embodiment differs from the first embodiment in that it further comprises an electrically insulative resin part 90 bonded from the end part 10b of the upper lid 10 to the lower lid 20 so as to cover a joint 99 between the upper lid 10 and lower lid 20.

Such a resin part 90 is easily obtained by applying an adhesive such as epoxy resin, for example.

This makes the end part of the crimping part 10b of the upper lid 10 harder to peel off than in the first embodiment.

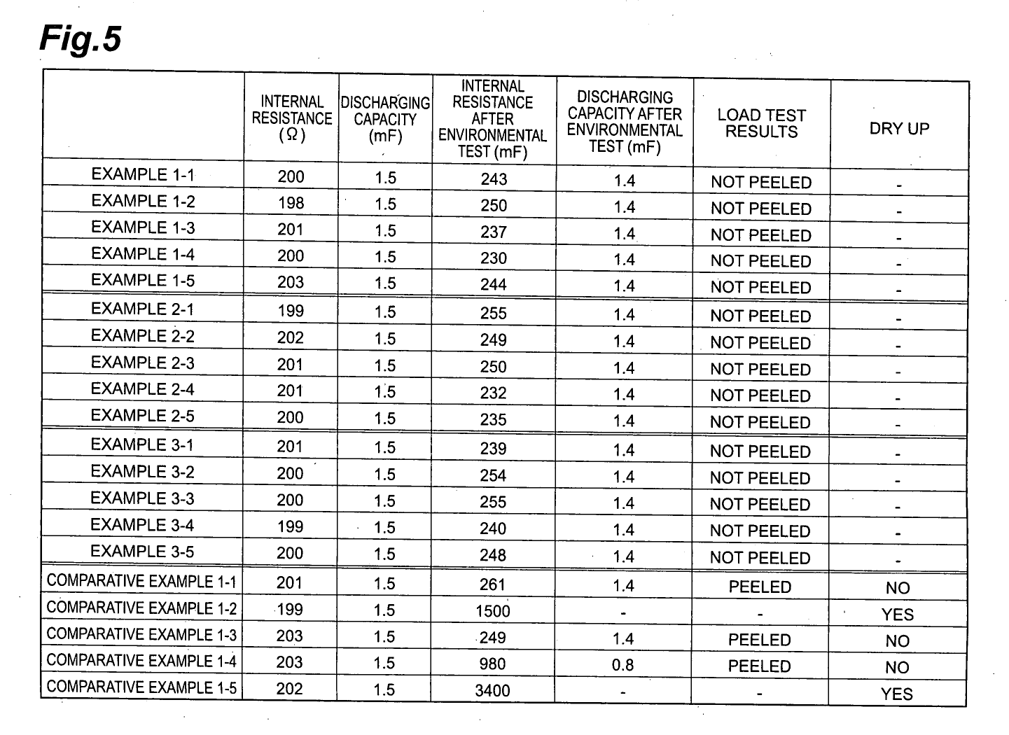

Forming such a resin part 90 is advantageous when mounting the electric double layer capacitor 200 onto the substrate 210 by using reflow soldering parts 215, 216 as shown in FIG. 4.

First, the reflow soldering part 216 is provided between the lower face of the lower lid 20 of the electric double layer capacitor 200 and a pattern 206 of a substrate 210, whereas the reflow soldering part 215 is provided between the lower side of the crimping part 10b of the upper lid 10 and a pattern 205 of the substrate 210. Subsequently, the electric double layer capacitor 200 and substrate 210 are put into a reflow furnace and heated there, so that the reflow soldering parts 215, 216 reflow, thereby connecting the lower lid 20 and pattern 206 to each other with solder, and connecting the upper lid 10 and pattern 20 to each other with solder.

Since the electrically insulative resin part 90 is formed so as to cover the joint 99 between the upper lid 10 and lower lid 20 in this case, the reflow soldering parts 215, 216 are less likely to be short-circuited when caused to reflow.

For more effectively restraining the crimping part 10b from peeling off, the gasket 40 bonds the crimping part 10b of the upper lid 10 and the brim 20b of the lower lid 20 to each other in this embodiment. However, providing the resin part 90 is more effective in restraining the crimping part 10b from peeling off than in conventional cases even when gasket 40 does not bond the upper lid 10 and lower lid 20 to each other.

Without being restricted to the above-mentioned embodiments, the electrochemical device in accordance with the present invention can be modified in various manners. For example, the electric double layer capacitor elements in the embodiments are not restricted to those having a three-layer structure, but may comprise five or more layers in which a plurality of electrodes and separators are alternately laminated so as to exhibit a function of a capacitor. As a separator, a solid electrolyte film (a film made of a solid polymer electrolyte or a film containing an ionically conductive inorganic material) may be used, for example.

The electrochemical element sealed within the container is not limited to the electric double layer capacitor element 30, but may also be a pseudocapacity capacitor, a redox capacitor, or the like. A primary battery element or a secondary battery element such as lithium-ion secondary battery element may also be used as the electrochemical element, whereby a primary battery, secondary battery, or the like as the electrochemical device is obtained.

Examples of the electric double layer capacitor in accordance with the embodiments will now be explained.

### EXAMPLES 1-1 TO 1-5

First, an aluminum foil having a thickness of 80 μm was punched out into a circular form, so as to be used as an upper lid. Subsequently, a similar aluminum foil was punched out into a circular form and then was drawn, so as to form a cylindrical part and a brim, thus yielding a lower lid. Next, an electric double layer capacitor element having a thickness of 350 μm was prepared.

This electric double layer capacitor element was one in which a positive electrode, a separator, and a negative electrode were laminated in this order, the positive and negative electrodes were made of porous activated carbon, the separator was a porous resin, and they contained an electrolytic solution made of a propylene solution containing 1.8 mol/L of triethylmethylammonium tetrafluoroborate.

After accommodating the electric double layer capacitor element into the lower lid, the upper lid was overlaid thereon with an annular gasket made of acid-denatured polyethylene interposed therebetween, and an end part of the upper lid was bent, so as to crimp the lower lid, thereby sealing the electric double layer capacitor element.

Subsequently, the gasket was heated, so that the upper and lower lids were bonded to each other with the gasket. By such a procedure, five electric double layer capacitors were made as Examples 1-1 to 1-5.

### EXAMPLES 2-1 TO 2-5

Electric double layer capacitors made as with Example 1-1 were each further provided with an adhesive made of a resin covering the joint between the upper and lower lids, whereby electric double layer capacitors of Examples 2-1 to 2-5 were obtained.

### EXAMPLES 3-1 TO 3-5

Electric double layer capacitors were produced as with Example 1-1 except that the gasket was not heated, and a resin covering the joint between the upper and lower lids was bonded to each of thus obtained electric double layer capacitors, whereby electric double layer capacitors of Examples 3-1 to 3-5 were made.

### COMPARATIVE EXAMPLES 4-1 TO 4-5

Electric double layer capacitors were produced as with Example 1-1 except that the gasket was not heated, whereby electric double layer capacitors of Comparative Examples 4-1 to 4-5 were made.

After measuring the initial internal resistance and discharging capacity, thus obtained electric double layer capacitors were left for 100 hours in an environment at a room temperature of 60° C. and a moisture of 90%, and their internal resistance and discharging capacity were measured thereafter. Further, while applying a load of 50 g to a portion of the crimping part of the upper lid, whether the crimping part peeled off or not was determined. When the discharging capacity was not measurable, it was verified whether or not the electric double layer capacitor elements were in a dry-up state in which the electrolytic solution was dried.

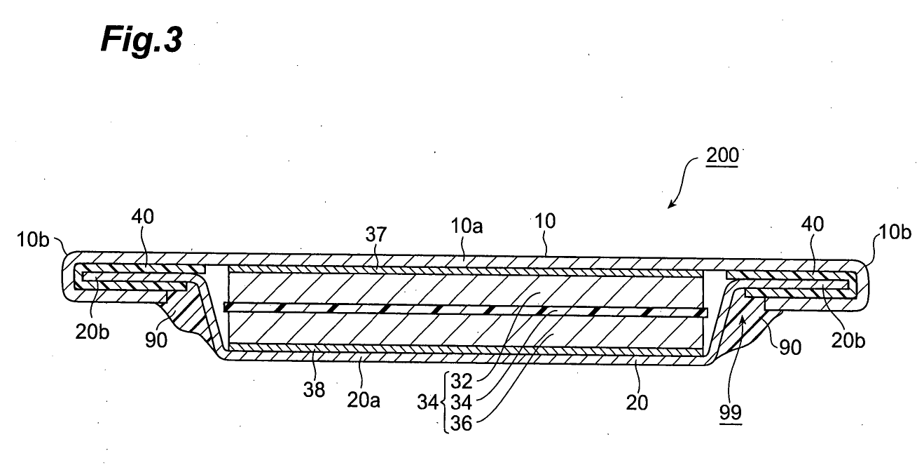

The table of FIG. 5 lists the initial internal resistance and discharging capacity, internal resistance and discharging capacity after the environmental test, load test results, and results of whether dry-up occurred or not in each of the electric double layer capacitors in accordance with the examples and comparative examples.

In Comparative Examples 1-1, 1-3, and 1-4, the crimping part peeled off in the load test. In Comparative Example 1-4, the internal resistance after the environmental test increased remarkably, whereas the discharging capacity after the environmental test decreased remarkably, thus indicating that sealability was poor. In Comparative Examples 1-2 and 1-5, the discharging capacity after the environmental test was not measurable, and substantially all the solvent of the electrolytic solution evaporated (dried up).

In each of the electric double layer capacitors of Examples 1-1 to 1-5, 2-1 to 2-5, and 3-1 to 3-5, on the other hand, the internal resistance and discharging amount after the environmental test fell in their appropriate ranges, while the crimping parts did not peel off in the load test.

These have verified that the present invention provides an electrochemical device whose crimping part is hard to disengage even when materials of its container and lids become thinner.

### INDUSTRIAL APPLICABILITY

In the electrochemical device in accordance with the present invention, a gasket bonds an end part of one container member to an end part of the other container member, or an electrically insulative resin is bonded from one container member to the other container member so as to cover the joint between one container member and the other container member. As a consequence, an end part of one container member, which is a crimped part, is harder to peel off. This makes it easier to keep the sealing performance in the electrochemical device even when the container members and lid members are made thinner.

1. An electrochemical device comprising:
an electrochemical element including a pair of electrode layers;
a pair of container members made of a metal surrounding the electrochemical element; and
an electrically insulative gasket, interposed between the pair of container members, for electrically insulating the container members from each other;
wherein the electrochemical element is sealed by causing an end part of one container member to crimp an end part of the other container member while interposing the gasket between the end part of one container member and the end part of the other container member, one of the pair of electrode layers being electrically connected to one container member, the other of the pair of electrode layers being electrically connected to the other container member; and
wherein the end part of one container member and the end part of the other container member are bonded to each other by the gasket.

2. An electrochemical device according to claim 1, wherein the gasket contains at least one of acid-denatured polypropylene and acid-denatured polyethylene.

3. An electrochemical device according to claim 1, wherein one container member and the other container member are bonded to each other by heating the gasket after causing the end part of one container member to crimp the end part of the other container member.

4. An electrochemical device comprising:
an electrochemical element including a pair of electrode layers;
a pair of container members made of a metal surrounding the electrochemical element; and
an electrically insulative gasket, interposed between the pair of container members, for electrically insulating the container members from each other;
wherein the electrochemical element is sealed by causing an end part of one container member to crimp an end part of the other container member while interposing the gasket between the end part of one container member and the end part of the other container member, one of the pair of electrode layers being electrically connected to one container member, the other of the pair of electrode layers being electrically connected to the other container member;
the electrochemical device further comprising an electrically insulative resin part bonded from one container member to the other container member so as to cover a joint between one container member and the other container member.

5. An electrochemical device according to claim 4, wherein the end part of one container member and the end part of the other container member are bonded to each other by the gasket.
